(19) United States
(12) Patent Application Publication
(10) Pub. No.: US 2011/0230990 A1
(43) Pub. Date: Sep. 22, 2011

(54) METHOD AND DEVICE FOR MODIFYING PLAYBACK OF DIGITAL MUSICAL CONTENT

(75) Inventors: Zi Kai Koh, Singapore (SG); Wong Hoo Sim, Singapore (SG)

(73) Assignee: CREATIVE TECHNOLOGY LTD, Singapore (SG)

(21) Appl. No.: 13/132,586

(22) PCT Filed: Nov. 24, 2009
(86) PCT No.: PCT/SG2009/000448

§ 371 Date: Jun. 2, 2011

(30) Foreign Application Priority Data
Dec. 9, 2008 (SG) 200809066-4

(51) Int. Cl. G06F 17/00

(52) U.S. Cl. 700/94

(57) ABSTRACT

There is provided a method and a device to modify playback of digital musical content. The digital musical content may be either stored on the handheld device or transmitted to the handheld device. The method may include playing back the digital musical content using the handheld device, the digital musical content being played back using pre-determined levels of at least one parameter of the digital musical content; detecting at least one motion the handheld device is undergoing; modifying the digital musical content in accordance with the at least one motion being detected; and playing back the modified digital musical content using the handheld device.

### FIELD OF INVENTION

This invention relates to playback of digital musical content, particularly in relation to a method and device for modifying playback of digital music content.

### BACKGROUND

Media playback functionality is becoming increasingly commonplace to users as media playback functionality is typically incorporated into both dedicated media playback devices and devices used for other functionalities. The devices used for other functionalities may include, for example, mobile phones, digital cameras, electronic navigation devices, mobile computers, portable gaming consoles and so forth. The proliferation of media playback functionality into devices has become so widespread that it is rare for a device to lack media playback functionality. Correspondingly, the widespread proliferation of media playback functionality in the devices is also due to demand for such functionality from buyers of the aforementioned devices.

Currently, the aforementioned devices are typically usable for playback of digital media content only. A user accessing the media playback functionality on the aforementioned devices typically has access to a selection of, for example, preferred audio settings, preferred appearance settings (skins), stored digital media content (images, songs and video). Thus, based on what is accessible by the user, it is evident that the user is only able to customize settings pertaining to media playback functionality, and select the media content for playback.

As such, there is currently no facility enabling either creation of original digital audio content or modification of existing digital audio content. In this regard, a more interactive type of experience between the user and the digital audio content is currently lacking. Such an experience would enhance the media playback functionality on the aforementioned devices for the user.

### SUMMARY

In a first aspect, there is provided a method for using a handheld device to modify playback of digital musical content. The digital musical content may be either stored on the handheld device or transmitted to the handheld device. The method may include playing back the digital musical content using the handheld device, the digital musical content being played back using pre-determined levels of at least one parameter of the digital musical content; detecting at least one motion the handheld device is undergoing; modifying the digital musical content in accordance with the at least one motion being detected; and playing back the modified digital musical content using the handheld device.

It is advantageous that the digital musical content may be modified either by varying at least one parameter of the digital musical content or scratching a juncture of the digital musical content. The at least one parameter may include, for example, volume, timbre, tempo and so forth. In some embodiments, the method may further include defining at least one position of constituent sound sources of the digital musical content. The constituent sound sources may be selected from, for example, percussion, solo instrument, woodwinds, brass, cello, bass, viola, violin and so forth.

It is advantageous that the modified digital musical content may be stored separately from the digital musical content, the digital musical content remaining in an original form. The modified digital musical content may be either stored on the handheld device or transmitted away from the handheld device for storage.

It is preferable that the at least one motion the handheld device is undergoing occurs when the handheld device is held by at least one hand of a user. The at least one motion may be selected from, for example, rotation of the handheld device about an axis of the handheld device, displacing the handheld device in a straight line, displacing the handheld device in an arc, any combination of the aforementioned and so forth. Preferably, detection of the at least one motion of the handheld device is performed by a motion sensing unit in the handheld device. Advantageously, each of the at least one motion is associated with either varying at least one parameter of the digital musical content or scratching a juncture of the digital musical content.

In a second aspect, there is provided a handheld device for modifying playback of digital musical content. The digital musical content may be either stored on the handheld device or transmitted to the handheld device.

The device may include a motion sensing unit for detecting at least one motion the handheld device is undergoing; a MIDI synthesizer for modifying the digital musical content in accordance with the at least one motion being detected; and an audio decoder to decode the modified digital musical content for playback. It is advantageous that the digital musical content is modified either by varying at least one parameter of the digital musical content or scratching a juncture of the digital musical content. The at least one parameter may be selected from, for example, volume, timbre, tempo and the like. The device may also include a control to enable a digital musical content modifying mode on the handheld device.

The modified digital musical content may be stored separately from the digital musical content, the digital musical content remaining in an original form. As such, the modified digital musical content may be either stored on the handheld device or transmitted away from the handheld device for storage.

Preferably, the at least one motion the handheld device is undergoing occurs when the handheld device is held by at least one hand of a user. The at least one motion may be selected from, for example, rotation of the handheld device about an axis of the handheld device, displacing the handheld device in a straight line, displacing the handheld device in an arc and any combination of the aforementioned and the like. It is preferable that each of the at least one motion is associated with either varying at least one parameter of the digital musical content or scratching a juncture of the digital musical content.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a process flow for a method of the present invention.

FIG. 2 shows a block diagram for a device of the present invention.

FIG. 3 shows sample movements for controlling volume of digital audio content in a preferred embodiment of the present invention.

FIG. 4 shows sample movements for controlling timbre of digital audio content in a preferred embodiment of the present invention.

FIG. 5 shows sample movements for controlling tempo of digital audio content in a preferred embodiment of the present invention.

FIG. 6 shows sample movements for scratching a juncture of digital audio content in a preferred embodiment of the present invention.

### DESCRIPTION OF PREFERRED EMBODIMENTS

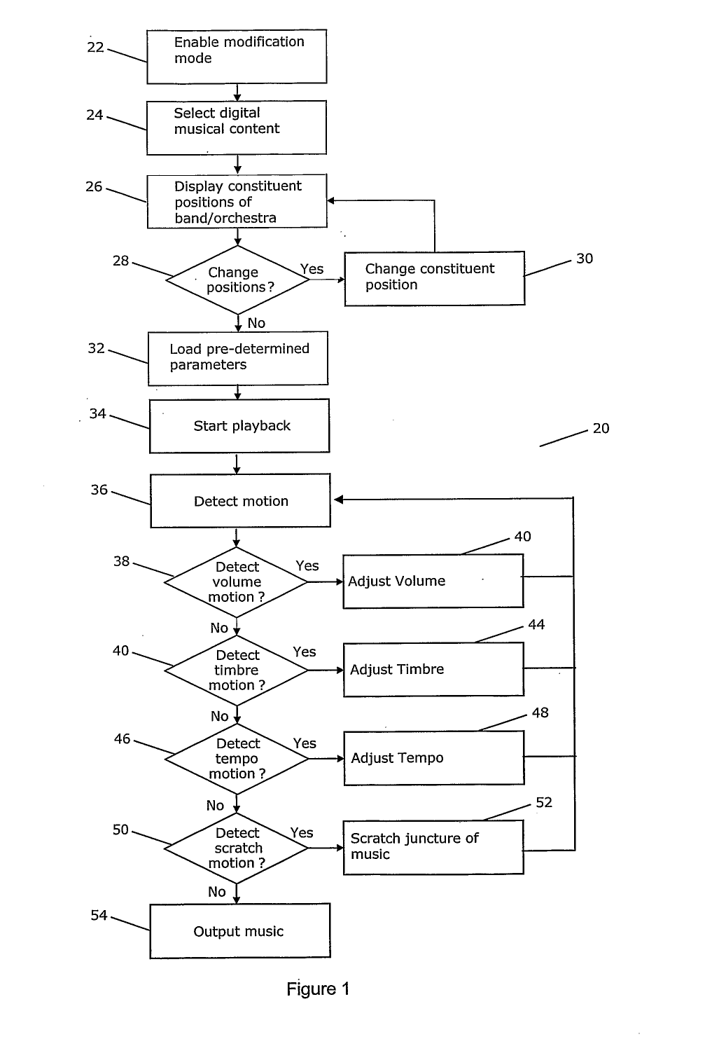

Referring to FIG. 1, there is provided a method 20 for using a handheld device to modify playback of digital musical content. The handheld device may include, for example, digital media players, mobile phones, digital cameras, electronic navigation devices, mobile computers, portable gaming consoles and so forth. The digital musical content may be either stored on the handheld device or transmitted to the handheld device. The playback of the digital musical content may be modified either by varying at least one parameter of the digital musical content or scratching a juncture the digital musical content. The at least one parameter of the digital musical content includes, for example, volume, timbre, tempo and so forth. The scratching of a juncture of the digital musical content may be carried out by incorporating turn-table scratching audio effects into the digital musical content. The digital musical content may be either broken or split-up at the juncture, and the turn-table scratching audio effects may be incorporated into the break/split of the digital musical content.

The method 20 may include enabling a modification mode 22 on the handheld device. The handheld device may include at least one pre-defined or definable control to enabling the modification mode on the handheld device. The control may include, for example, a switch, a sensor, a virtual activator on a touch screen, and so forth. It may be necessary to continually press the at least one pre-defined or definable control during the modification mode. However, it may also be possible to press the at least one pre-defined or definable control only once to enable the modification mode.

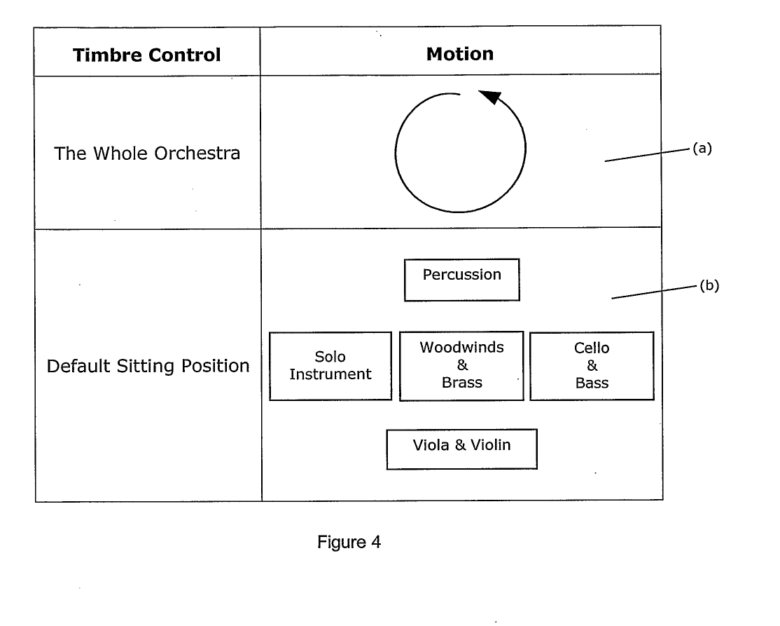

Subsequently, after the modification mode 22 has been enabled on the handheld device, at least one digital musical content is selected 24 to undergo modification. The digital musical content may include digital audio files with file extensions such as, for example, mp3, way, mid, ogg, and so forth. After the at least one digital musical content is selected, positions of constituent sound sources for the selected digital musical content are displayed, as shown in FIG. 4(b). The positions of constituent sound sources may be displayed 26 on, for example, a display on the handheld device, an external display functionally connected to the handheld device, both of the aforementioned and so forth. The display on the handheld device may be a screen such as, for example, TFT, LCD and OLED. The display may be a touch sensitive panel (touchscreen). The external display functionally connected to the handheld device may be either a large display or head-mounted display. The constituent sound sources may include, for example, percussion, solo instrument, woodwinds, brass, cello, bass, viola, violin and other orchestral sound sources.

The positions of the constituent sound sources may be varied 28. When the positions of the constituent sound sources are varied 30, a user is consequently able to review the positions of the constituent sound sources as varied 26 on, for example, a display on the handheld device, an external display functionally connected to the handheld device, both of the aforementioned and so forth.

When there are no further changes to the positions of the constituent sound sources, pre-determined levels of at least one parameter of the selected digital musical content are loaded 32 for playback. Subsequently, playback of the selected digital musical content is initiated 34.

During playback of the selected digital musical content using the handheld device in the modification mode, at least one motion the handheld device is undergoing is detected 36. The digital musical content is modified in accordance with the at least one motion being detected. The at least one motion the handheld device is detected to be undergoing may occur when the handheld device is held by at least one hand of the user. The detection of the at least one motion of the handheld device may be performed by a motion sensing unit in the handheld device. The motion sensing unit may include, for example, accelerometers, magnetic field sensors, gyro-sensors, digital compass and the like. The motion sensing unit may be coupled to a processor. The motion sensing unit may obtain information such as either or both positional and radial changes of the handheld device. The motion sensing unit may have sensing tolerances incorporated into the motion sensing unit to prevent non-deliberate motion from being detected. It should be appreciated that the motion sensing unit may be a separate peripheral which is functionally connected with the handheld device either via a wired or wireless connection.

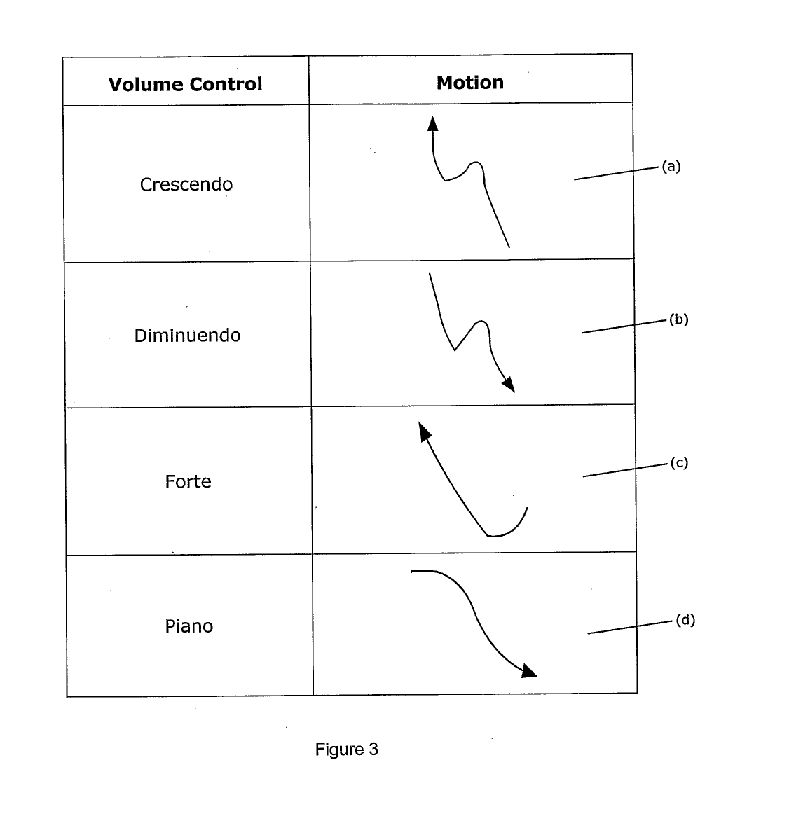

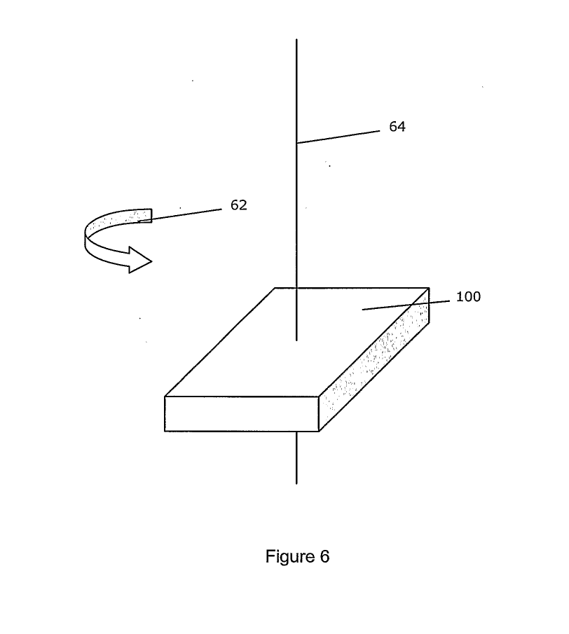

The at least one motion being detected by the motion sensing unit may include, for example, rotation of the handheld device about an axis of the handheld device (as shown in FIG. 6), displacing the handheld device in a straight line, displacing the handheld device in an arc, and any combination of the aforementioned (as shown in FIGS. 3 to 5). Each of the at least one motion which is detected may be associated with either varying at least one parameter of the digital musical content or scratching a juncture of the digital musical content.

FIG. 3 shows non-limiting examples of motions for varying volume of the selected digital musical content. The motions may be similar to that of an orchestral conductor and enables the user to control, for example, crescendos, diminuendos, fortes, pianos and so forth. Referring to FIG. 3, it can be seen that varying, for example, crescendos (FIG. 3(a)), diminuendos (FIG. 3(b)), fortes (FIG. 3(c)), pianos (FIG. 3(d)) and so forth requires the handheld device to be moved in a combination of straight lines and curves. A mute function may be invoked by either causing the handheld device to undergo a particular motion (not shown) or by using a mute control on the handheld device. The mute control may include, for example, a switch, a sensor, a virtual activator on a touch screen, and so forth. Thus, if the motion sensing unit detects motions 38 for varying volume of the selected digital musical content, the volume of the selected digital musical content is correspondingly adjusted 40.

FIG. 4 shows a non-limiting example of a motion for varying timbre of the selected digital musical content. These motions allow the user to select whether the whole orchestra is playing the music (FIG. 4(a)), or which section of the orchestra is involved (FIG. 4(b)). The sections of the orchestra may be the constituent sound sources such as, for example, percussion, solo instrument, woodwinds, brass, cello, bass, viola, violin and other orchestral sound sources. Selecting the required section to be involved may involve pointing the handheld device in a general direction of the required section (with reference to FIG. 4(b)) at a frontal region of the user holding the handheld device. The frontal region of the user may be a region in front of a line of sight of the user. A representation of FIG. 4(b) may be shown on the display of the handheld device to aid the user in pointing the handheld device in the appropriate general direction. Thus, if the motion sensing unit detects motions 42 for varying timbre of the selected digital musical content, the timbre of the selected digital musical content is correspondingly adjusted 44.

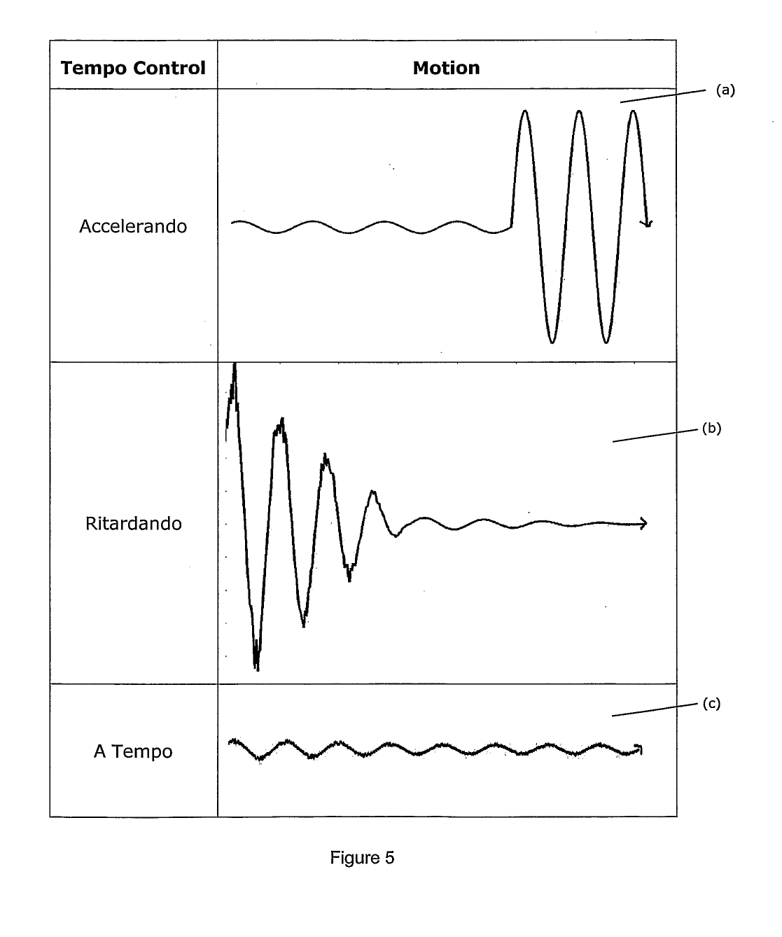

FIG. 5 shows non-limiting examples of motions for varying tempo of the selected digital musical content. ‘Accelerando’ (FIG. 5(a)) denotes a motion for the tempo to be sped up. ‘Ritardando’ (FIG. 5(b)) denotes a motion for the tempo to be slowed down. Finally, ‘A tempo’ (FIG. 5(c)) denotes a motion to allow the tempo to revert to the pre-defined tempo of the selected digital musical content. Thus, if the motion sensing unit detects motions 46 for varying tempo of the selected digital musical content, the tempo of the selected digital musical content is correspondingly adjusted 48.

FIG. 6 shows a non-limiting example of a motion for scratching a juncture of the selected digital musical content. It can be seen that a handheld device 100 is rotated 62 about an axis 64 of the handheld device 100 in an anti-clockwise direction to scratch a juncture of the selected digital musical content. It should be appreciated that rotation of the handheld device 100 about the axis 64 in a clockwise direction may also enable scratching of a juncture of the selected digital musical content. Thus, if the motion sensing unit detects motions 50 for scratching a juncture of the selected digital musical content, that juncture of the selected digital musical content is correspondingly scratched 52.

The aforementioned variations and insertions to the selected digital musical content may be carried out by a MIDI synthesizer controlled by the processor coupled to the motion sensing unit. The processor typically processes signals from the motion sensing unit and sends corresponding instructions to the MIDI synthesizer to vary and make the requisite insertions to the selected digital musical content accordingly.

Even when variations and/or insertions to the selected digital musical content have been made because of the motions detected by the motion sensing unit, motion is still continually detected 36 in the method 20 by the motion sensing unit while the selected digital musical content is played back. This is because the user may wish to vary/make insertions to the selected digital musical content at any time during playback of the selected digital musical content. This detection of motion by the motion sensing unit ceases only on the completion of playback for each digital musical content.

Finally, the modified digital musical content is played back 54 using the handheld device. The modified digital musical content may be played back though a sound output device such as, for example, at least one earphone, at least one earpiece of a headphone, at least one speaker and so forth. The sound output device may be incorporated within the handheld device and may also include an amplifier. The modified digital musical content may be stored separately from the selected digital musical content, the selected digital musical content remaining in an original form. The modified digital musical content may be either stored on the handheld device in a non-volatile memory device or transmitted away from the handheld device for storage. Thus, the modified digital musical content may be accessed at a later time for review if necessary.

It should be appreciated that an order of steps in the method 20 as described in the preceding paragraphs need not be strictly adhered to in the present invention. Variations to the order of the steps in the method 20 may be made without departing from the present invention.

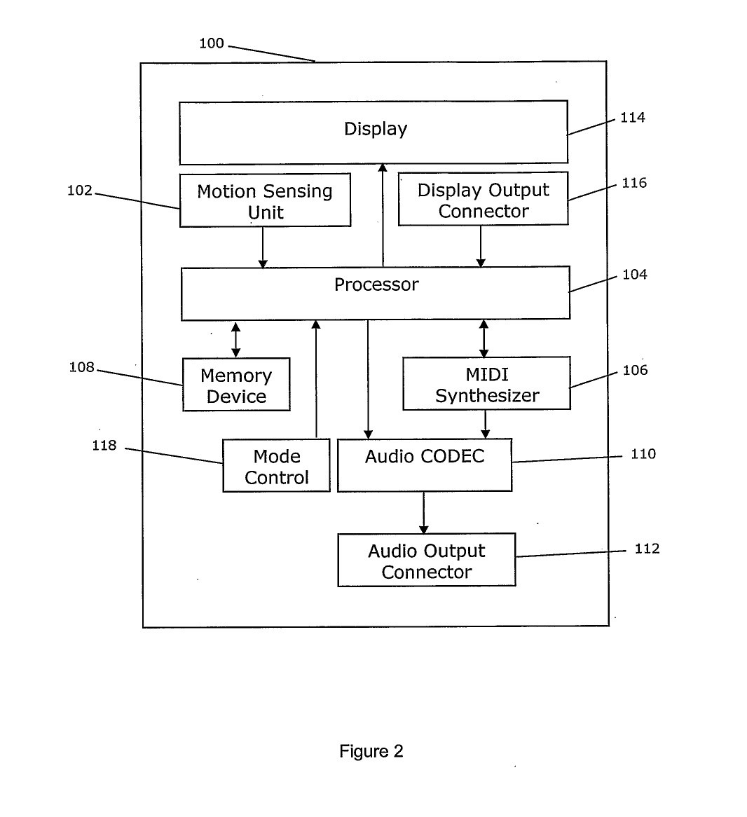

Referring to FIG. 2, there is shown a block diagram of a handheld device 100 for modifying playback of digital musical content. The handheld device 100 may include, for example, digital media players, mobile phones, digital cameras, electronic navigation devices, mobile computers, portable gaming consoles and so forth. The digital musical content may be either stored on the handheld device 100 or transmitted to the handheld device 100. The playback of the digital musical content may be modified either by varying at least one parameter of the digital musical content or scratching a juncture the digital musical content. The scratching of a juncture of the digital musical content may be carried out by incorporating turn-table scratching audio effects into the digital musical content. The digital musical content may be either broken or split-up at the juncture, and the turn-table scratching audio effects may be incorporated into the break/split of the digital musical content. The at least one parameter of the digital musical content includes, for example, volume, timbre, tempo and so forth. The digital musical content may include digital audio files with file extensions such as, for example, mp3, way, mid, ogg, and so forth.

The handheld device 100 may include a display 114. The display 114 on the handheld device 100 may be a screen such as, for example, TFT, LCD and OLED. The display 114 may be a touch sensitive panel (touchscreen). There may also be a display output connector 116 which allows an external display functionally connected to the handheld device 100. The external display functionally connected to the handheld device 100 may be either a large display or head-mounted display. Either the display 114 or the external display may display, for example, positions of constituent sound sources of the digital musical content. The constituent sound sources may include, for example, percussion, solo instrument, woodwinds, brass, cello, bass, viola, violin and other orchestral sound sources.

The handheld device 100 includes a motion sensing unit 102 for detecting at least one motion the handheld device 100 is undergoing when the handheld device 100 is grasped in the user's hand. The motion sensing unit 102 may have sensing tolerances incorporated into the motion sensing unit 102 to prevent non-deliberate motion from being detected. The digital musical content is modified in accordance with the at least one motion being detected by the motion sensing unit 102. The motion sensing unit 102 may include, for example, accelerometers, magnetic field sensors, gyro-sensors, digital compass and the like. The motion sensing unit 102 may be coupled to a processor 104. The motion sensing unit 102 may obtain information such as either or both positional and radial changes of the handheld device 100. It should be appreciated that the motion sensing unit 102 may be a separate peripheral which is functionally connected with the handheld device 100 either via a wired or wireless connection.

The at least one motion being detected by the motion sensing unit 102 may include, for example, rotation of the handheld device 100 about an axis of the handheld device 100 (as shown in FIG. 6), displacing the handheld device 100 in a straight line, displacing the handheld device 100 in an arc, and any combination of the aforementioned (as shown in FIGS. 3 to 5). Each of the at least one motion which is detected may be associated with either varying at least one parameter of the digital musical content or scratching a juncture of the digital musical content.

FIG. 3 shows non-limiting examples of motions for varying volume of the digital musical content. The motions may be similar to that of an orchestral conductor and enables the user to control, for example, crescendos (FIG. 3(a)), diminuendos (FIG. 3(b)), fortes (FIG. 3(c)), pianos (FIG. 3(d)) and so forth. Referring to FIG. 2, it can be seen that varying, for example, crescendos, diminuendos, fortes, pianos and so forth requires the handheld device 100 to be moved in a combination of straight lines and curves. A mute function may be invoked by either causing the handheld device 100 to undergo a particular motion (not shown) or by using a mute control on the handheld device 100. The mute control may include, for example, a switch, a sensor, a virtual activator on a touch screen, and so forth. Thus, if the motion sensing unit 102 detects motions for varying volume of the digital musical content, the volume of the digital musical content is correspondingly adjusted.

FIG. 4 shows a non-limiting example of a motion for varying timbre of the digital musical content. These motions allow the user to select whether the whole orchestra is playing the music (FIG. 4(a)), or which section of the orchestra is involved (FIG. 4(b)). The sections of the orchestra may be the constituent sound sources such as, for example, percussion, solo instrument, woodwinds, brass, cello, bass, viola, violin and other orchestral sound sources. Selecting the required section to be involved may involve pointing the handheld device 100 in a general direction of the required section (with reference to FIG. 4(b)) at a frontal region of the user holding the handheld device 100. The frontal region of the user may be a region in front of a line of sight of the user. A representation of FIG. 4(b) may be shown on the display 114 of the handheld device 100 to aid the user in pointing the handheld device 100 in the appropriate general direction. Thus, if the motion sensing unit 102 detects motions for varying timbre of the digital musical content, the timbre of the digital musical content is correspondingly adjusted.

FIG. 5 shows non-limiting examples of motions for varying tempo of the digital musical content. ‘Accelerando’ (FIG. 5(a)) denotes a motion for the tempo to be sped up. ‘Ritardando’ (FIG. 5(b)) denotes a motion for the tempo to be slowed down. Finally, ‘A tempo’ (FIG. 5(c)) denotes a motion to allow the tempo to revert to the pre-defined tempo of the digital musical content. Thus, if the motion sensing unit 102 detects motions for varying tempo of the digital musical content, the tempo of the digital musical content is correspondingly adjusted.

FIG. 6 shows a non-limiting example of a motion for scratching a juncture of the digital musical content. It can be seen that a handheld device 100 is rotated 62 about an axis 64 of the handheld device 100 in an anti-clockwise direction to scratch a juncture of the digital musical content. It should be appreciated that rotation of the handheld device 100 about the axis 64 in a clockwise direction may also enable scratching of a juncture of the digital musical content. Thus, if the motion sensing unit 102 detects motions for scratching a juncture of the digital musical content, that juncture of the digital musical content is correspondingly scratched.

The handheld device 100 may include a MIDI synthesizer 106 for modifying the digital musical content in accordance with the at least one motion being detected by the motion sensing unit 102. The variations and/or insertions to the digital musical content may be carried out by the MIDI synthesizer 106 controlled by a processor 104 coupled to the motion sensing unit 102. The processor 104 typically processes signals from the motion sensing unit 102 and sends corresponding instructions to the MIDI synthesizer 106 to vary the digital musical content accordingly. The motion sensing unit 102 is continually detecting motion because the user may wish to vary and/or make insertions to the selected digital musical content at any time during playback of the digital musical content. This detection of motion by the motion sensing unit 102 ceases only on the completion of playback each digital musical content. There may also be an audio decoder 110 controlled by the processor 104 to decode the modified digital musical content for playback.

The handheld device 100 may include at least one pre-defined or definable mode control 118 to enabling a modification mode on the handheld device 100. The mode control 118 may include, for example, a switch, a sensor, a virtual activator on a touch screen, and so forth. It may be necessary to continually press the at least one pre-defined or definable mode control 118 during the modification mode. However, it may also be possible to press the at least one pre-defined or definable mode control 118 only once to enable the modification mode. The mode control 118 may be coupled to the processor 104 to send instructions to the processor 104 to enable the modification mode.

The modified digital musical content may be played back using the handheld device 100. The modified digital musical content may be played back though an audio output connector 112. Devices such as, for example, at least one earphone, at least one earpiece of a headphone, at least one speaker and so forth may be connected to the connector 112.

The modified digital musical content may be stored separately from the selected digital musical content, the selected digital musical content remaining in an original form. The modified digital musical content may be either stored on the handheld device 100 in a non-volatile memory device 108 or transmitted away from the handheld device 100 for storage. Thus, the modified digital musical content may be accessed at a later time for review if necessary.

It should be appreciated that the method 20 and the device 100 enables a more interactive type of experience between the user and digital audio content. Such an experience enhances the media playback functionality on devices with media playback functionality.

Whilst there has been described in the foregoing description preferred embodiments of the present invention, it will be understood by those skilled in the technology concerned that many variations or modifications in details of design or construction may be made without departing from the present invention.

1. A method for using a handheld device to modify playback of digital musical content, the method including:
playing back the digital musical content using the handheld device, the digital musical content being played back using pre-determined levels of at least one parameter of the digital musical content;
detecting at least one motion the handheld device is undergoing;
modifying the digital musical content in accordance with the at least one motion being detected; and
playing back the modified digital musical content using the handheld device,
wherein the digital musical content is modified either by varying at least one parameter of the digital musical content or scratching a juncture of the digital musical content.

2. The method of claim 1, wherein the modified digital musical content is stored separately from the digital musical content, the digital musical content remaining in an original form.

3. The method of claim 2, wherein the modified digital musical content is either stored on the handheld device or transmitted away from the handheld device for storage.

4. The method of claim 1, wherein the digital musical content is either stored on the handheld device or transmitted to the handheld device.

5. The method of claim 1, wherein the at least one parameter is selected from a group comprising: volume, timbre, and tempo.

6. The method of claim 1, wherein the at least one motion the handheld device is undergoing occurs when the handheld device is held by at least one hand of a user.

7. The method of claim 1, further including defining at least one position of constituent sound sources of the digital musical content.

8. The method of claim 7, wherein each of the constituent sound sources is selected from the group comprising: percussion, solo instrument, woodwinds, brass, cello, bass, viola, and violin.

9. The method of claim 1, wherein the at least one motion is selected from a group comprising: rotation of the handheld device about an axis of the handheld device, displacing the handheld device in a straight line, displacing the handheld device in an arc, and any combination of the aforementioned.

10. The method of claim 1, wherein detection of the at least one motion of the handheld device is performed by a motion sensing unit in the handheld device.

11. The method of claim 1, wherein each of the at least one motion is associated with either varying at least one parameter of the digital musical content or scratching a juncture of the digital musical content.

12. A handheld device for modifying playback of digital musical content, the device including:
a motion sensing unit for detecting at least one motion the handheld device is undergoing;
a MIDI synthesizer for modifying the digital musical content in accordance with the at least one motion being detected; and
an audio decoder to decode the modified digital musical content for playback,
wherein the digital musical content is modified either by varying at least one parameter of the digital musical content or scratching a juncture of the digital musical content.

13. The handheld device of claim 12, wherein the modified digital musical content is stored separately from the digital musical content, the digital musical content remaining in an original form.

14. The handheld device of claim 13, wherein the modified digital musical content is either stored on the handheld device or transmitted away from the handheld device for storage.

15. The handheld device of claim 12, wherein the digital musical content is either stored on the handheld device or transmitted to the handheld device.

16. The handheld device of claim 12, wherein the at least one parameter is selected from a group comprising: volume, timbre, and tempo.

17. The handheld device of claim 12, wherein the at least one motion the handheld device is undergoing occurs when the handheld device is held by at least one hand of a user.

18. The handheld device of claim 12, wherein the at least one motion is selected from a group comprising: rotation of the handheld device about an axis of the handheld device, displacing the handheld device in a straight line, displacing the handheld device in an arc, and any combination of the aforementioned.

19. The handheld device of claim 12, wherein each of the at least one motion is associated with either varying at least one parameter of the digital musical content or scratching a juncture of the digital musical content.

20. The handheld device of claim 12, further including a control to enable a digital musical content modifying mode on the handheld device.
